(19) United States
(12) Patent Application Publication
(10) Pub. No.: US 2006/0212425 A1
(43) Pub. Date: Sep. 21, 2006

(54) Distributed product information management

(75) Inventors: Jouni Tapani Stam, Espoo (FI); Timo Tapani Nurminen, Helsinki (FI); Petri Juhani Kuusinen, Veikkola (FI)

Correspondence Address: NIXON PEABODY, LLP, 401 9TH STREET, NW, SUITE 900, WASHINGTON, DC, 20004-2128, US

(73) Assignee: Stockway Oy, Espoo (FI)

(21) Appl. No.: 10/535,899

(22) PCT Filed: Dec. 1, 2003
(86) PCT No.: PCT/FI03/00915

§ 371 Date: Feb. 7, 2006

(30) Foreign Application Priority Data
Dec. 2, 2002 (FI) 20022123

(51) Int. Cl. G06F 17/30

(52) U.S. Cl. 707/3

(57) ABSTRACT

The present invention discloses a method and a system for managing distributed product information. The products (30) are equipped with unique product information code (31). Unique codes indicate information stored to information hosts (34, 36, 38). The hosts are aware of other hosts and if the host does not have any information about requested product the request is directed to the next host. The product information comprises links to all hosts having information about requested product. When ever a new product code is added to the host it will advertise the code to the other hosts having information relating to the same product code.

### FIELD OF THE INVENTION

The present invention relates to distributed material handling. Specifically the present invention concerns distributed product information management.

### BACKGROUND OF THE INVENTION

Material handling and product distribution is one of the most important issues in businesses of today. Delivering materials and products is expensive and it has to be well organized and optimized. Because of the expenses huge investments have been made to logistic systems. The present logistic systems typically optimize distribution of materials and products and produce information for internal use of the systems.

The present solutions for providing product information to customers use a server, e.g. a web server that is linked to other servers. In an importer or retailer page there might be links to manufacturer and retailer pages and vice versa. The problem of this solution is the diversity. In the web there are thousands of servers that contain information about different products. If the customer does not know from where to search the information the task of finding it becomes difficult.

In typical prior art solutions product are equipped with a unique code, such as a bar code, and the corresponding information is stored in to a server. The utilization of a paper based bar code is discussed e.g. in patent application WO 02/33518. The bar code is scanned and processed. Typically the bar code is a UPC (Universal Product Code) as in U.S. Pat. No. 6,430,554. In U.S. Pat. No. 6,430,554 a computer is used to read and analyze the UPC of the product. Typically the UPC is coded to a bar code but it can be included also in a magnetic tag.

The tag may also be some other unique code besides UPC as US patent application 2002007325 and WO 01/79988 indicate. In WO 01/79988 the product is in a container or a package, which is equipped with a tag. The tag comprises needed information to retrieve further information, such as an Internet address or other information access code. Publications US 2002010651 and WO 01/79988 suggest a solution for information retrieving. The both solutions are based on a centralized database. U.S. Pat. No. 6,240,335 suggests a distributed solution for material handling. The distributed solution according to U.S. Pat. No. 6,240,335, however, comprises a top-level controller.

The drawback of the above mentioned solutions is a need for centralized system. Centralized systems are critical to breakdowns. During server break the whole system might be unusable. Further drawback of centralized database is the huge amount of data. Very good system should have information about any product. Database consisting information about all products of the logistic world would be very large. The further drawback of centralized database is the administration and updating of data. The administration should be handled so that the whole supply chain could add information about the product. Thus there is an obvious need for an efficient method for material handling and information management.

### PURPOSE OF INVENTION

The purpose of the invention is to disclose a new method for product information management. Particularly the invention discloses a distributed method and system for product information management.

### SUMMARY OF THE INVENTION

The present invention discloses a method and a system for distributed information management. The method is applied in an information host network comprising independent information hosts. The information hosts are contacted with a terminal device. The terminal device may be any general terminal device such as a computer or a mobile terminal.

The method according to the invention is initiated by contacting the first information host. The first information host can be any information host from the network. Typically first host is a book marked host and the same host is always contacted first. The first host may be, however, selected also freely so that the service is usable also in case of breakdown of the usual first host.

When the host has been contacted information requests may be processed. The user requests information with a unique product code. The code may be read from a bar code, a magnetic tag or similar identifier. If there is no reading device available the code may also be entered manually. The request is submitted to the information host.

The information host starts searching according to the request. First the information host searches its own database. If information is found it will be displayed to the client. The information typically contains information about the product but it may also contain links to further information of the product. The information is arranged in a way that the host knows all other hosts containing information about the product. Whenever a new host containing information about the product is founded it is informed to other host having information about the product. The hosts may comprise information about products and materials so that the client can have information on both. For example the client is searching information about a jacket and is interested in materials used in the jacket. The client searches the jacket and as a result he/she will get an information sheet, which has information about jacket. The sheet includes a relation between the items so that the information about the jacket would have a relation to the raw materials of the jacket. If he/she wants more specific information about the material he/she can follow the relation or search the material from the information host.

If there is no information in the first information host it redirects the request to the next information host. Whenever the first host having information about requested product is found, links to all hosts having requested information are found.

The method according to the invention discloses an efficient way of distributed information management. The method according to the invention provides a possibility to search information about any product in the network.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 is a flow chart of the searching method according to the present invention,

FIG. 2 is a flow chart of the storing method according to the present invention, and

FIG. 3 is a diagram illustrating a system according to one embodiment of the present invention.

### DETAILED DESCRIPTION OF THE INVENTION

Reference will now be made in detail to the embodiments of the present invention, examples of which are illustrated in the accompanying drawings.

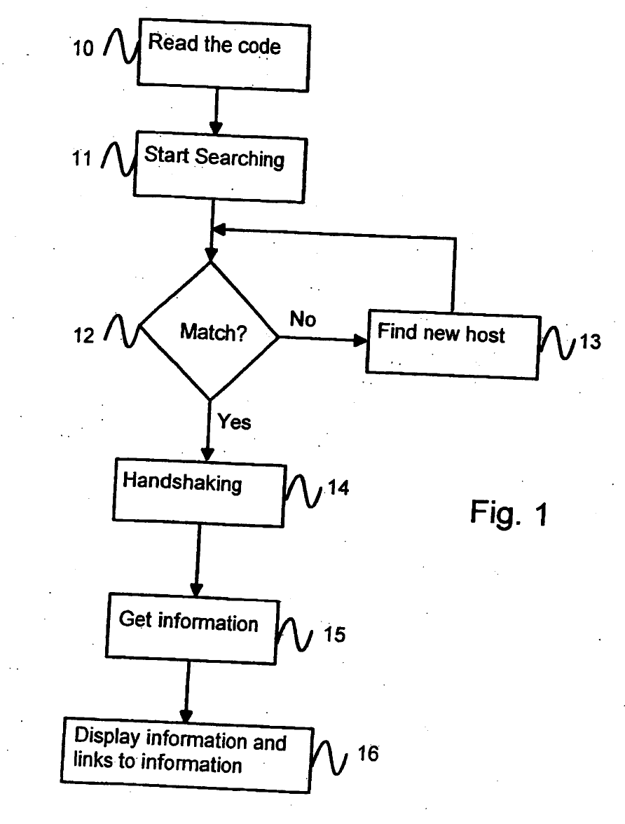

FIG. 1 illustrates a method for searching product information from a network of the information hosts. Searching is initiated by reading a product code from a product, step 10. The product may be any product or service that can be assigned unique identification code. The product code may also be entered manually. The product code is individual so that it indicates the product uniquely. The product code is transferred to the first information host, which starts searching information about the product, step 11. Typically first host is always same host and it is set as a default host to the client terminal the customer is using. First host starts searching from a database. The database is local for the host so that it does not share databases with other hosts. The host has also a list of addresses of other hosts. The list does not need to be complete and typically the list does not comprise any other information besides the addresses. If there is no information corresponding the code the host will redirect the request to the next host, step 13.

First host sends requests to other hosts and when a host containing information about the product is found a handshaking procedure between the terminal and the host is initiated, step 14. During the handshaking procedure the terminal and the host negotiate about communication parameters. The parameters include e.g. communication protocol. The handshaking procedure may be also done between the hosts while the terminal communicates only with first host. After the handshaking procedure the host searches the information from database, step 15. The information may comprise product information and links to other hosts having information about same product. The information and links are displayed to the customer, step 16. The amount of redirecting steps may be limited or kept track to avoid loops between the information hosts.

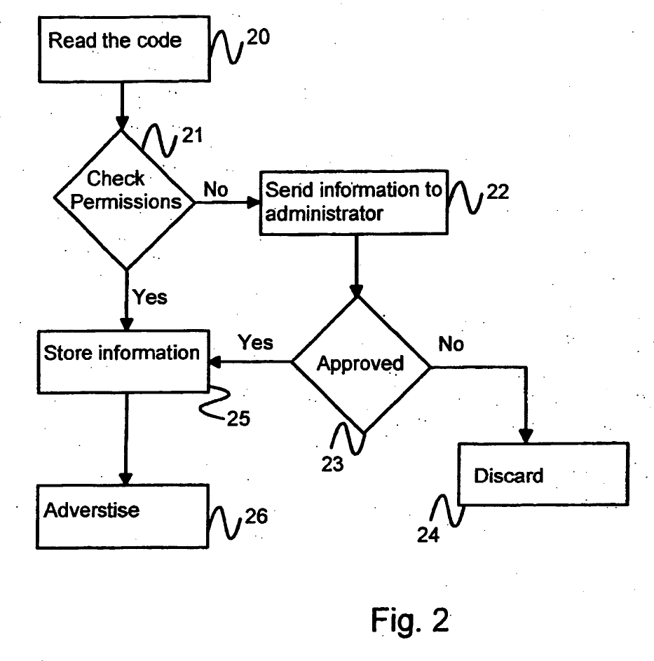

FIG. 2 illustrates a method for storing information to the network of product information hosts. Product information is stored according to the unique product code. Codes can be protected so that storing the information is allowed only to the selected group, which typically include manufacturer, importer and retailers. The manufacturer gets unique code from the system administrator. Typically product codes are assigned in a manner in which the manufacturer assigns a prefix to the code. The manufacturer assigns unique codes for each importer so that the importer prefix consists of a manufacturer code and importer code. The assigned importer code is controlled by the importer.

The manufacturer has given all permissions relating to the importer prefix to the importer level. Importer may similarly assign new codes to the retailers so that the prefix part comprises three different codes. The suffix part may be an EAN-code, a barcode or similar. This procedure guarantees universally unique product code to each product. This means that the product will have unique codes for different coding systems even if the same product had been inserted to two different information systems at the same time.

Assigned codes are always verified. Verification can be made e.g. with digital signatures. Typically the product code is unique to each individual product but the product code may be assigned to a model or product type.

The product code is read from the product or inserted manually, step 20. The information host checks the permissions, step 21. If the information provider does not have permission to store the information, it is sent to the administrator, step 22. The administrator decides whether the information is valid, step 23. Typically the decision is done automatically with digital signatures or other certificates. If the information is not valid it will be discarded, step 24.

If the user has the permission to insert the information or the administrator approves the information it is inserted to the database, step 25. If there is no previous information regarding to the product code the information should be informed also to other hosts. During the informing procedure the other hosts containing the information about the product are found. The links of the other hosts are stored to the database, step 26. The information inserting procedure creates a product information network. The information providers may send information messages to each others so that the information network can provide information concerning the whole supply chain. If the information changes in the supply chain the other information providers are informed. This is possible e.g. in cases where the product to be delivered gets lost or damaged during the transportation. The information providers are informed about the situation and the customer can be notified. The information network is product centric and typically all the information relates to a product or products.

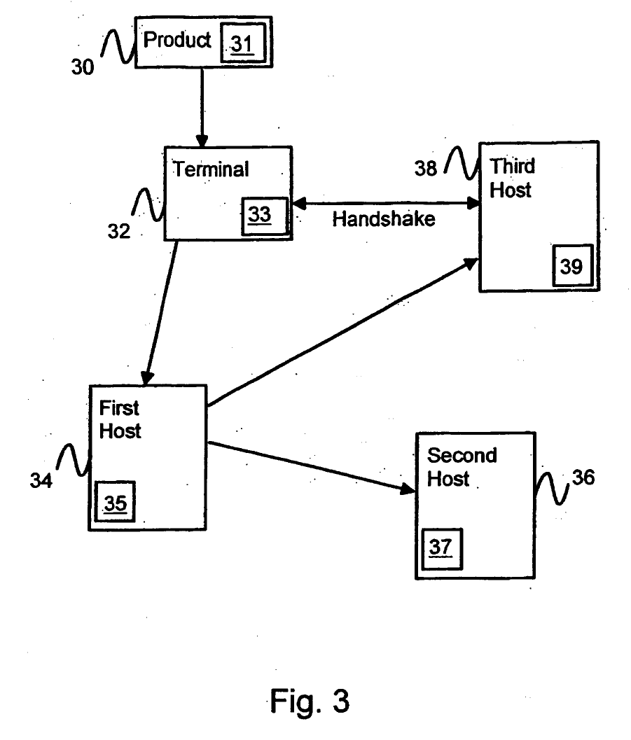

FIG. 3 illustrates a system according to the invention. The system consists of a product, a terminal device and a set of information hosts. The product 30 has a unique product information code 31. The terminal device 32 reads the code 31 with a reading tool 33. The reading tool may be a barcode scanner or a magnetic tag reader. The product code 31 may also be entered manually to the terminal device. The terminal device 32 starts searching by contacting the first host 34. The first host is typically set as default host so that the search always starts from same host. There may be also a list of secondary hosts in case that the first host does not work. The first host 34 searches its database 34. If the first host 34 does not have information about the product 30 the search request is directed to the second host 36 which searches its database 37. In the example illustrated in FIG. 3 the information is found from the third host 38. The third host 38 searches its database 39 and finds requested information. Information will be transferred directly to the terminal 32. The third host 38 initiates a handshake procedure. During the handshake the third host and the terminal device negotiate about transferring parameters, which include e.g. communication protocol.

It is obvious to a person skilled in the art that with the advancement of technology, the basic idea of the invention may be implemented in various ways. The invention and its embodiments are thus not limited to the examples described above, instead they may vary within the scope of the claims.

1. A distributed information management method for searching information in an information host network comprising independent information hosts the method comprising following steps:
inserting a unique product identification code;
contacting the first information host;
requesting information with the unique identification code;
searching the requested information according to said identification code;
characterized in that the method further comprises following steps:
displaying founded results or redirecting the request according to the host information and said identification code to secondary information host; and
repeating said redirecting step when contacted secondary host does not have information on requested identification code.

2. The method according to claim 1, characterized in that the product information comprises links to further information on other information hosts.

3. The method according to claim 1, characterized in that the handshaking procedure is utilized between the terminal and the host in case of the information is found on secondary information host.

4. The method according to claim 1 or 3, characterized in that the amount of the redirecting steps is limited.

5. A distributed information management method for storing and providing information in an information host network, comprising independent information hosts method comprising following steps:
reading a unique product identification code;
selecting a information host;
contacting selected information host;
checking the permissions for storing information; and
storing the information;
characterized in that the checking the permissions for storing the information against product code that consists of a prefix and a suffix, in which the prefix code comprises fields for different administration levels.

6. The method according to claim 5, characterized in that the information is redirected to administrator if storing information is not permitted.

7. The method according to claim 5, characterized in that the method further comprises a step: informing the new information to other information host in case that the product code indicating the information is not previously known.

8. The method according to claim 7, characterized in that the informing comprises further steps:
searching a host having information about the product code;
reading the links to all information hosts having information about the product code; and
informing the hosts about the new information host.

9. The method according to claim 5, characterized in that the validity of the code fields is verified with digital signatures.

10. A distributed information management system, which system comprises a product having a unique product information code, a terminal device for reading the product code and a set of information hosts characterized in that the set of information hosts consist of independent information hosts each information host comprising a database and said information hosts are arranged to perform and redirect searches to secondary information hosts if the requested information is not available in the primary host.

11. The system according to claim 10, characterized in that the system comprises a list of other known information hosts.

12. The system according to claim 10, characterized in that the system is arranged to redirect the search requests to secondary host if the information host does not have information about requested product.

13. The system according to claims 10 or 12, characterized in that the system is arranged to utilize handshake procedure between the terminal and secondary host for enabling direct communication.

14. The system according to claim 10 characterized in that the system is arranged to check users permission when storing the information.

15. The system according to claim 10 characterized in that the system is arranged to inform other information hosts about stored information which is indicated by previously unknown product code.

16. The system according to claim 10 characterized in that the system is arranged to verify information host permissions while registering as an information provider to the network.
